(19) United States
(12) Patent Application Publication
(10) Pub. No.: US 2017/0060987 A1
(43) Pub. Date: Mar. 2, 2017

(54) ONLINE SERVICES SURFACING AND USING RELATIONSHIP TEMPERATURES

(71) Applicant: LinkedIn Corporation, Mountain View, CA (US)

(72) Inventors: Xin Hu, San Jose, CA (US); Haider Sabri, Redwood City, CA (US); Heidi Jaywing Wang, Cupertino, CA (US)

(21) Appl. No.: 14/834,246

(22) Filed: Aug. 24, 2015

(51) Int. Cl. G06F 17/30; G06F 3/0482; G06F 3/0484

(52) U.S. Cl. CPC G06F 17/30604; G06F 3/0484; G06F 3/0482; G06F 17/30864

(57) ABSTRACT

In some embodiments, a relationship temperature value for a first user of an online social networking service is accessed or received. The relationship temperature value indicates a measurement of activity of the first user with respect to one or more other users of the online social networking service. In some example embodiments, a function of the online social networking service is performed based on the relationship temperature value. In some example embodiments, the function comprises generating content for display to the first user.

### TECHNICAL FIELD

The present application relates generally to data processing systems and, in one specific example, to methods and systems of using a measurement of the activity level of social networking connections by an online service.

### BACKGROUND

Currently, online social networking services are limited in their ability to accurately and efficiently determine and represent the quality of a relationship between different members or other users of the social networking service.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram illustrating a client-server system, in accordance with an example embodiment;

FIG. 2 is a block diagram showing the functional components of a social networking service within a networked system, in accordance with an example embodiment;

FIG. 3 is a block diagram illustrating components of a relationship temperature system, in accordance with an example embodiment;

FIG. 4 illustrates a table of social activity data, in accordance with an example embodiment;

FIG. 5 illustrates a table of relationship temperature data, in accordance with an example embodiment;

FIG. 6 illustrates a graphical representation of a relationship temperature value, in accordance with an example embodiment;

FIG. 7 illustrates a graphical representation of recent touch points of activity between users of a social networking service, in accordance with an example embodiment;

FIG. 8 illustrates a graphical representation of opportunities for interaction, in accordance with an example embodiment;

FIG. 9 illustrates a graphical user interface (GUI) displaying corresponding indications of relationship temperature values for connections of a user of a social networking service, in accordance with an example embodiment;

FIG. 10 illustrates GUI displaying an indication of a relationship temperature value on a profile page of a user, in accordance with an example embodiment;

FIG. 11 illustrates GUI displaying indications of social activity data, in accordance with an example embodiment;

FIG. 12 illustrates GUI displaying indications of social activity data, in accordance with an example embodiment;

FIG. 13 illustrates GUI displaying indications of social activity data, in accordance with an example embodiment;

FIG. 14 illustrates GUI displaying indications of social activity data, in accordance with an example embodiment;

FIG. 15 illustrates GUI displaying indications of social activity data, in accordance with an example embodiment;

FIG. 16 illustrates GUI displaying indications of social activity data, in accordance with an example embodiment;

FIG. 17 illustrates GUI displaying indications of social activity data, in accordance with an example embodiment;

FIG. 18 illustrates GUI displaying an indication of a relationship temperature value and indications of social activity data, in accordance with an example embodiment;

FIG. 19 illustrates GUI displaying an indication of a relationship temperature value and indications of social activity data, in accordance with an example embodiment;

FIG. 20 illustrates an inbox of a user having messages ordered based on corresponding relationship temperature values of the user for the senders of the messages, in accordance with an example embodiment;

FIG. 21 is a flowchart illustrating a method of performing functions of a social networking service using relationship temperature values, in accordance with an example embodiment;

FIG. 22 is a flowchart illustrating a method of determining one or more relationship temperature values, in accordance with an example embodiment;

FIG. 23 is a block diagram illustrating a system architecture, in accordance with an example embodiment;

FIG. 24 is a flow diagram illustrating maintenance of online and offline data stores, in accordance with an example embodiment;

FIG. 25 is a flow diagram illustrating maintenance of a data store for persisting periodic temperature values, in accordance with an example embodiment;

FIG. 26 is a block diagram illustrating a mobile device, in accordance with some example embodiments; and

FIG. 27 is a block diagram of an example computer system on which methodologies described herein may be executed, in accordance with an example embodiment.

### DETAILED DESCRIPTION

Example methods and systems of providing a measurement of the activity level for social networking connections are disclosed. In the following description, for purposes of explanation, numerous specific details are set forth in order to provide a thorough understanding of example embodiments. It will be evident, however, to one skilled in the art that the present embodiments may be practiced without these specific details.

The present disclosure introduces techniques of determining and using a relationship temperature value. The relationship temperature value is a measurement representing an activity level of a user (e.g., a user or member of an online social networking service) with respect to one other specific user or a group of other users (e.g., all members of an online social networking service that are identified as connections of the user, or a group of multiple users from those connections).

In some example embodiments, social activity data corresponding to a first user and one or more other users of an online social networking service is accessed or received, with the social activity data comprising one or more signals, and each of the one or more signals indicating a corresponding activity of the first user with respect to one of the one or more other users. In some example embodiments, a relationship temperature value for the first user is calculated, or otherwise determined, based on the social activity data, with the calculating of the relationship temperature value comprising weighting each activity inversely proportional to an amount of time that has elapsed since that activity has occurred, and the relationship temperature value is stored in a database in association with the first user. In some example embodiments, the relationship temperature value comprises a numerical score.

In some example embodiments, the one or more signals comprises at least one of the first user establishing a connection with one of the one or more other users, the first user commenting on an event associated with the one of the one or more other users, the first user sending a message to the one of the one or more other users, the first user calling the one of the one or more other users, the first user having a meeting with the one of the one or more other users, the first user inviting the one of the one or more other users to use an online service, the first user being within a predetermined proximity of the one of the one or more other users, the first user following the one of the one or more other users, the first user liking an event associated with the one of the one or more other users, and the first user answering a question about the one of the one or more other users.

In some example embodiments, the calculating of the relationship temperature value is performed at regular intervals. In some example embodiments, the calculating of the relationship temperature value is performed based on a request for the relationship temperature value by a function of the online social networking service configured to generate content.

In some example embodiments, the one or more other users consists of a second user, and the relationship temperature value represents a measurement of activity by the first user with respect to the second user. In some example embodiments, the one or more other users comprises a plurality of other users, and the relationship temperature value represents a measurement of activity by the first user with respect to the plurality of other users. In some example embodiments, the one or more other users consists only of the plurality of other users, the plurality of other users consists only of all of the users identified as connections of the first user in the online social networking service, and the relationship temperature value represents a measurement of activity by the first user with respect to all of the users identified as connections of the first user in the online social networking service. In some example embodiments, calculating the relationship temperature value comprises calculating a corresponding relationship temperature sub-value for each one of the plurality of other users based on the social activity data, with the calculating of the corresponding relationship temperature sub-value comprising weighting each activity of the first user with respect to the corresponding other user inversely proportional to an amount of time that has elapsed since that activity has occurred, calculating a sum of the corresponding relationship temperature sub values, and dividing the sum by the number of user in the plurality of other users.

In some example embodiments, an establishment of a connection between the first user and one of the one or more other users is detected, and, in response to the detecting the establishment of the connection, the relationship temperature value is initialized based on a common number of connections shared by the first user and the one of the one or more other users.

In some example embodiments, a function of the online social networking service is performed based on the relationship temperature value, with the function comprising generating content for display to the first user. In some example embodiments, the content generated for display to the first user comprises an indication of the relationship temperature value. In some example embodiments, the content generated for display to the first user comprises a prompting to perform an action with respect to the one or more other users.

In some example embodiments, a relationship temperature value for a first user of an online social networking service is accessed or received, with the relationship temperature value indicating a measurement of activity of the first user with respect to one or more other users of the online social networking service, and a function of the online social networking service is performed based on the relationship temperature value, with the function comprising generating content for display to the first user. In some example embodiments, the relationship temperature score comprises a numerical score.

In some example embodiments, the content generated for display to the first user comprises an indication of the relationship temperature value. In some example embodiments, the content generated for display to the first user comprises a prompting to perform an action with respect to the one or more other users. In some example embodiments, the content generated for display to the first user comprises a graphical representation of a plurality of opportunities for interaction by the first user with the one or more other users, the graphical representation indicating which of the plurality of opportunities have been acted upon by the first user and which of the plurality of opportunities have not been acted upon by the first user. In some example embodiments, the content generated for display to the first user comprises a graphical representation of the relationship temperature value over a period of time, the graphical representation comprising different values of the relationship temperature value at different points during the period of time. In some example embodiments, the content generated for display to the first user comprises an inbox of messages of the first user, and the generating of the content comprises determining an order of messages in the inbox based on the relationship temperature value.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

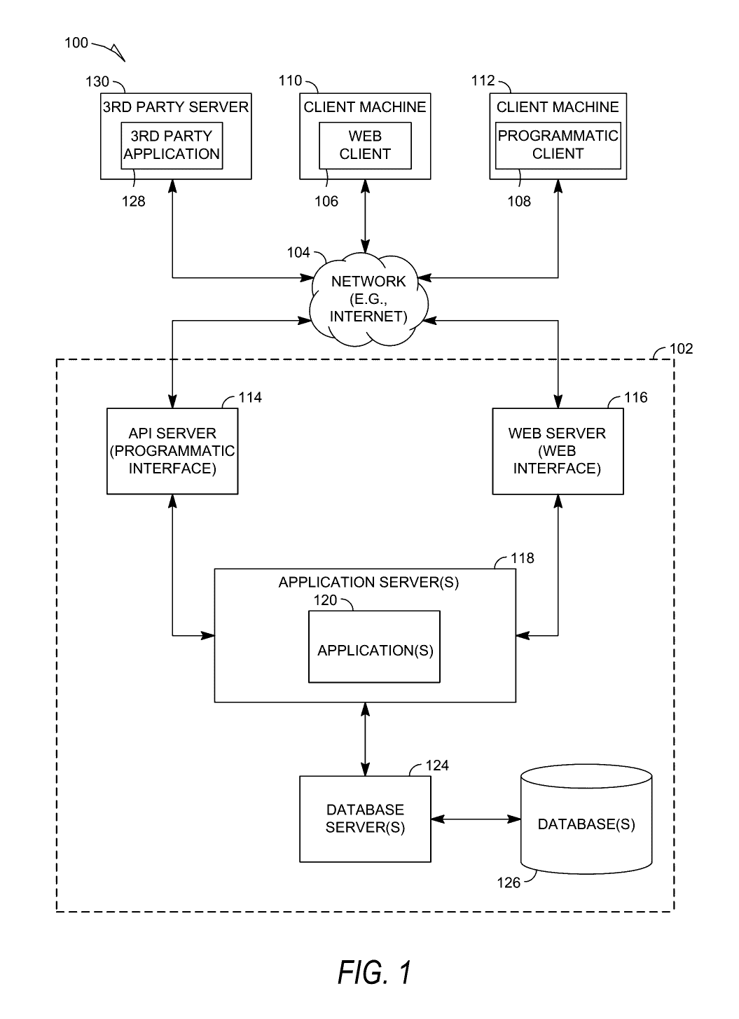

FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 117.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, the any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

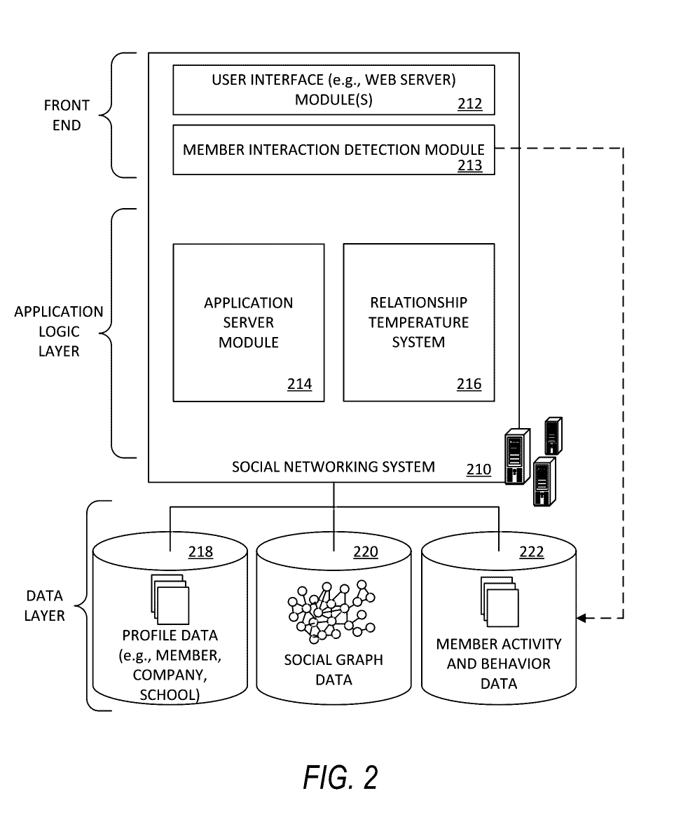

In some embodiments, the networked system 102 may comprise functional components of a social networking service. FIG. 2 is a block diagram showing the functional components of a social networking system 210, including a data processing module referred to herein as a relationship temperature system 216, for use in social networking system 210, consistent with some embodiments of the present disclosure. In some embodiments, the relationship temperature system 216 resides on application server 118 in FIG. 1. However, it is contemplated that other configurations are also within the scope of the present disclosure.

As shown in FIG. 2, a front end may comprise a user interface module (e.g., a web server) 212, which receives requests from various client computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction and detection module 213 may be provided to detect various interactions that members have with different applications, services and content presented. As shown in FIG. 2, upon detecting a particular interaction, the detection module 213 logs the interaction, including the type of interaction and any meta-data relating to the interaction, in the activity and behavior database with reference number 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service.

As shown in FIG. 2, a data layer may include several databases, such as a database 218 for storing profile data, including both member profile data as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database with reference number 218. Similarly, when a representative of an organization initially registers the organization with the social networking service, the representative may be prompted to provide certain information about the organization. This information may be stored, for example, in the database with reference number 218, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require a hi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with reference number 220.

As members interact with the various applications, services and content made available via the social networking system 210, the ‘members’ interactions and behavior (e.g., content viewed, links or buttons selected, messages responded to, etc.) may be tracked and information concerning the member's activities and behavior may be togged or stored, for example, as indicated in FIG. 2 by the database with reference number 222. This logged activity information may then be used by the relationship temperature system 216 to determine relationship temperature values for the users of the social networking system 210.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the relationship temperature system 216 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

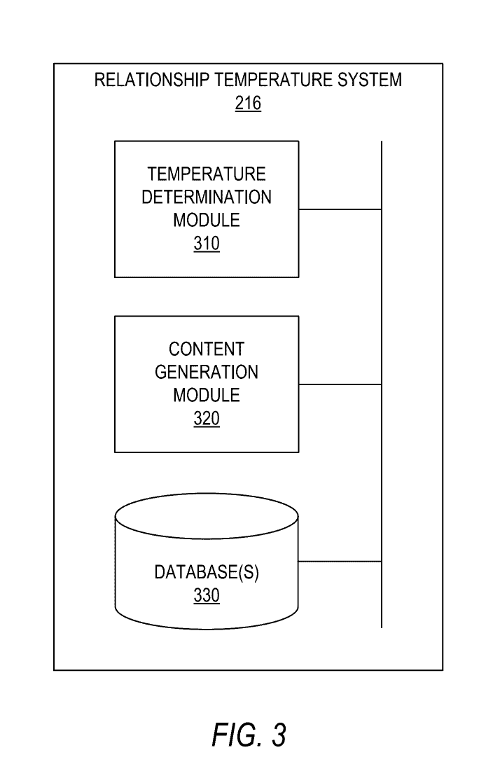

FIG. 3 is a block diagram illustrating components of the relationship temperature system 216, in accordance with an example embodiment. In some embodiments, the relationship temperature system 216 comprises any combination of one or more of a temperature determination module 310, a content generation module 320, and one or more database(s) 330. The temperature determination module 310 and the content generation module 320 can reside on a machine having a memory and at least one processor (not shown). In some embodiments, these modules 310 and 320 can be incorporated into the application server(s) 118 in FIG. 1. In some example embodiments, the database(s) is incorporated into database(s) 126 in FIG. 1 or into any combination of one or more of databases 218, 220, and 222 in FIG. 2. However, it is contemplated that other configurations of the modules 310 and 320, as well as the database(s) 330, are also within the scope of the present disclosure.

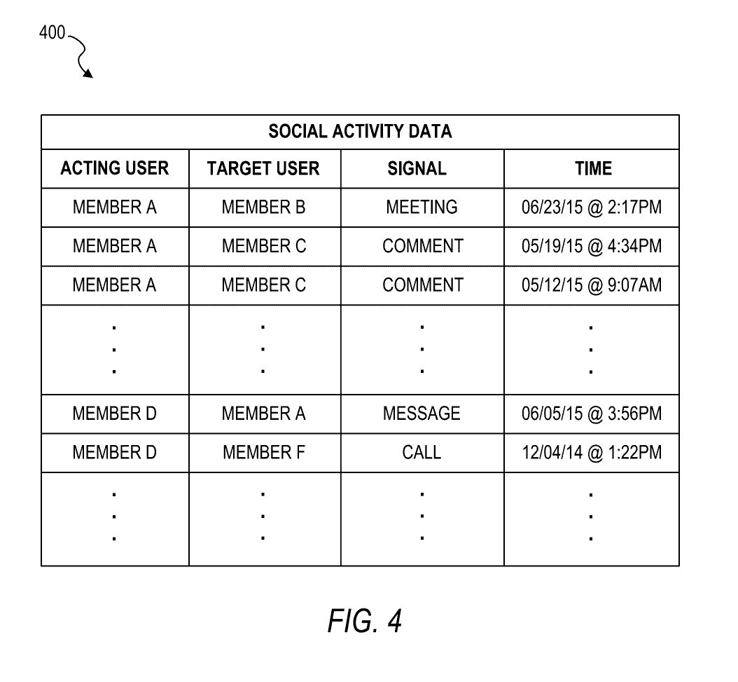

In some example embodiments, the temperature determination module 310 is configured to access or receive social activity data corresponding to a first user and one or more other users of an online social networking service or some other online service or entity). FIG. 4 illustrates a table 400 of social activity data, in accordance with an example embodiment. The table 400 can be stored in database(s) 330, although other embodiments are also within the scope of the present disclosure. In some example embodiments, the temperature determination module 310 accesses and retrieves social activity data from the table 400.

The social activity data can comprise one or more signals, with each of the one or more signals indicating a corresponding activity of an acting user with respect to a target user. For example, if a first user performs an activity with respect to another user, such as sending the other user a message, then the social activity data can include a record of this activity, including an identification of the first user as the acting user (e.g., the user performing the activity), an identification of the other user as the target user (e.g., the user that is the recipient or associated with content that is the recipient of the activity), an identification of the signal (e.g., an identification of the type of activity), and time data indicating when the corresponding activity was performed (e.g., the date and/or time at which the activity was performed).

One example of a signal indicating activity comprises a user establishing a connection with another user. A user establishing a connection with another user (e.g., clicking a “Connect” button to confirm an association of the user's profile with the other user's profile) can be used as a signal of activity. In some example embodiments, the relationship temperature values disclosed herein are only determined for registered members of an online social network service (e.g., user that have a registered profile or account with the online social network service) with respect to other members of the service. In some example embodiments; the relationship temperature values disclosed herein are only determined between members that have an established connection. However, it is contemplated that, in some example embodiments; the determination of relationship temperature values disclosed herein can be applied to non-members and non-connections as well.

Another example of a signal indicating activity comprises a user commenting on an event associated with another user. For example, the user posting a comment on the other user's profile page or on some other page or content of the other user can be used as a signal of activity.

Yet another example of a signal indicating activity comprises a user sending a message to another user. For example, the user sending a text, e-mail, or social media message (e.g., via LinkedIn, Facebook, Twitter, and the like) can be used as a signal of activity.

Yet another example of a signal indicating activity comprises a user calling another user. The signal indicating the call can be obtained via the call history on the user's phone, although other ways of detecting such a signal are also within the scope of the present disclosure.

Yet another example of a signal indicating activity comprises a user having a meeting with another user. The meeting signal can be obtained via the user's electronic calendar.

Yet another example of a signal indicating activity comprises a user being within a predetermined proximity of another user. For example, the location of the user and the location of the other user can be determined via Global Positioning System (GPS) technology, an indoor positioning system (e.g., using Wi-Fi infrastructure), or any other technology to determine relative positioning of two users.

Other examples of signals indicating activity include a user inviting another user to use an online service, a user viewing a profile of another user, a user following another user, and a user liking an event associated with another user.

Yet another example of a signal indicating activity comprises a user answering a question about another user. For example, the temperature determination module 310 can present, to the user, questions that test the user's knowledge about the other user (e.g., “What is John Smith's job title?”, Where does “Jane Doe work?”, “How many years has Joyce Kim been working for Company X?”). The act of the user answering a question, as well as whether the user answered the question correctly, can be used as a signal.

Other types of signals indicating activity are also within the scope of the present disclosure, including, but not limited to, an indication from a wearable device (e.g., a head mounted display) that a user is looking or otherwise oriented towards another user, as well as an indication from a biometric device of a user's biometric data with respect to another user (e.g., high pulse or blood pressure when in proximity to other user).

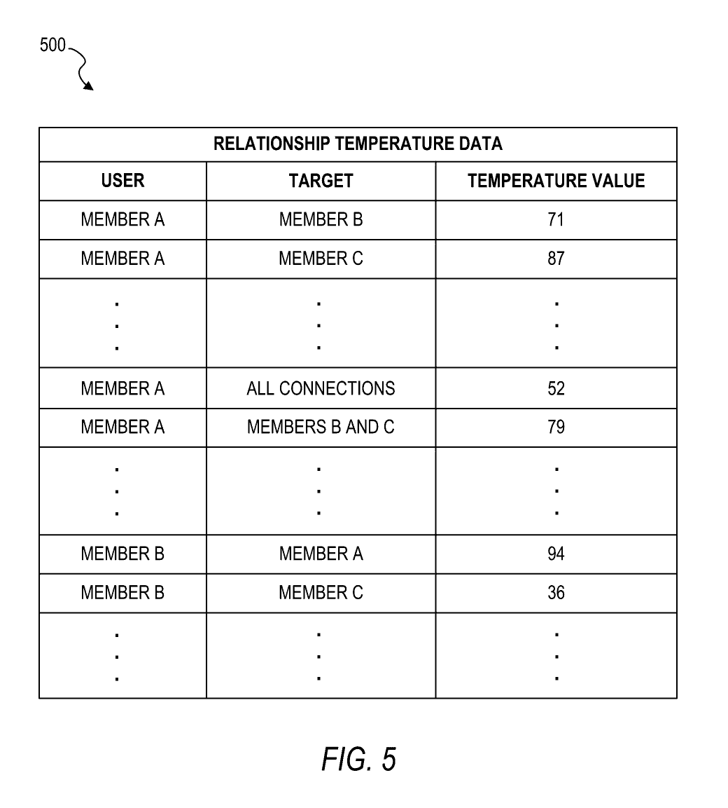

In some example embodiments, the temperature determination module 310 is configured to calculate, or otherwise determine, a relationship temperature value for a user based on the social activity data corresponding to that user. The temperature determination module 310 can store the relationship temperature value in association with the user in a database (e.g., database(s) 330). FIG. 5 illustrates a table 500 of relationship temperature data for different groupings of users, which can be stored in a database, in accordance with an example embodiment. Although the example in FIG. 5 shows the relationship temperature values comprising numerical scores, it is contemplated that non-numerical values are also within the scope of the present disclosure.

A relationship temperature value can be determined for and correspond to a user's activity level with respect to one other user (e.g., Member A's relationship temperature value with respect to Member B), with respect to all members of the online social networking service with whom the user is connected (e.g., Member A's relationship temperature value with respect to all members that are connected to Member A), or with respect to a grouping of two or more other users (e.g., Member A's relationship temperature value with respect to Members and C). The relationship temperature values can be determined in both directions of a relationship or connection, such that a different relationship temperature value can be determined for a first user with respect to a second user than for the second user with respect to the first user. For example, if the social activity data indicates that the first user is more active with respect to the second user than the second user is active with respect to the first user (e.g., the first user frequently sends messages to the second user and likes content associated with the second user, while the only activity the second user has engaged in with respect to the first user is a single phone call), then the relationship temperature value for the first user with respect to the second user can be higher than the relationship temperature value for the second user with respect to the first user.

In some example embodiments, the relationship temperature value is derived from the number and frequency of activities (e.g., actions) a user has taken with respect to another user or other users over a specified period of time. The temperature determination module 310 can sample the social activity data from a specified period of time (e.g., the last 6 months). Each activity engaged in by the user can be assigned a value. In some example embodiments, this value is based, at least in part, on a classification or type of the activity. For example, activities that are considered more involved or more personal (e.g., a phone call, a meeting) can be assigned higher values than activities that are considered less involved or less personal (e.g., liking content). These values can be stored in the database(s) 330 for retrieval and user during the calculation of a relationship temperature value.

In some example embodiments, in calculating a relationship temperature value, the temperature determination module 310 weights the activities based on when the activity occurred. For example, the temperature determination module 310 can be configured to weight each activity inversely proportional to the amount of time that has elapsed since that activity has occurred, meaning that the more recently an activity has occurred, the higher that activity is weighted, and the less recent the activity is, the lower that activity is weighted.

In some example embodiments, a relationship temperature value for a first user with respect to another user can be initialized in response to a connection being established between the first user and the other user. The initialized value can be based on a common number of connections shared by the first user and the other users (e.g., connection strength). The relationship temperature value can then be updated based on new social activity data, using the initialized value as a baseline. In one example embodiment, the following method of calculating and updating the relationship temperature value is used:

$$temp = connection\_strength * α + ( {\sum }_{i = 1}^{n} ( {activity}_{i} * {β}_{i} * ( \frac{1}{{time}_{i}} ) ) ) * ( 1 - α ) ,$$

where temp is the relationship temperature value, connection_strength is the common number of connections shared by the first user and the other user for which the relationship temperature value is being calculated, a is the weight assigned to the connection_strength, n is the number of activity signals being used in the calculation, activity is the activity signal (e.g., the action or other activity corresponding to a user with respect to another user, such as a user sending a message to another user), β is the weight assigned to the corresponding activity based on a classification of the corresponding activity (e.g., what type of activity: sending a message to the other user, following the other user, liking content associated with the other user, etc.), and time is the amount of time that has elapsed since the activity occurred. It is contemplated that other ways of calculating and updating the relationship temperature value are also within the scope of the present disclosure.

In some example embodiments, the calculating of the relationship temperature value is performed at regular intervals. For example, the relationship temperature value can be calculated once every 24 hours (e.g., at midnight every night). In some other example embodiments, the calculating of the relationship temperature value is performed based on a request for the relationship temperature value by a function of the online social networking service configured to generate content. For example, if a specific function of the online social networking service benefits from a premature update of the relationship temperature value to account for the most recent social activity data (e.g., activity within the last 30 minutes), then the calculation of the relationship temperature value can be triggered by a request before the scheduled regular interval update.

As previously mentioned, in addition to a relationship temperature value being determined for a user with respect to another user, a relationship temperature value can also be determined for a user with respect to a group of other users, such as all other users that are connected to the user or a subset of all such users. In some example embodiments, in calculating a relationship temperature value for a user with respect to a plurality of other users, the temperature determination module 310 is configured to calculate a corresponding relationship temperature sub-value for each one of the plurality of other users based on the social activity data, as previously discussed, and then calculate the average of the relationship temperature sub-values, such as by calculating a sum of the corresponding relationship temperature sub-values, and dividing the sum by the number of users in the plurality of other users. The relationship temperature value for the user with respect to the plurality of other users can then be assigned to be equal to, or otherwise be based on, the calculated average of the sub-values.

In some example embodiments, the content generation module 320 is configured to perform one or more functions of the online social networking service based on one or more of the relationship temperature values. One example of such a function comprises generating content for display to the user for which the relationship temperature value was determined.

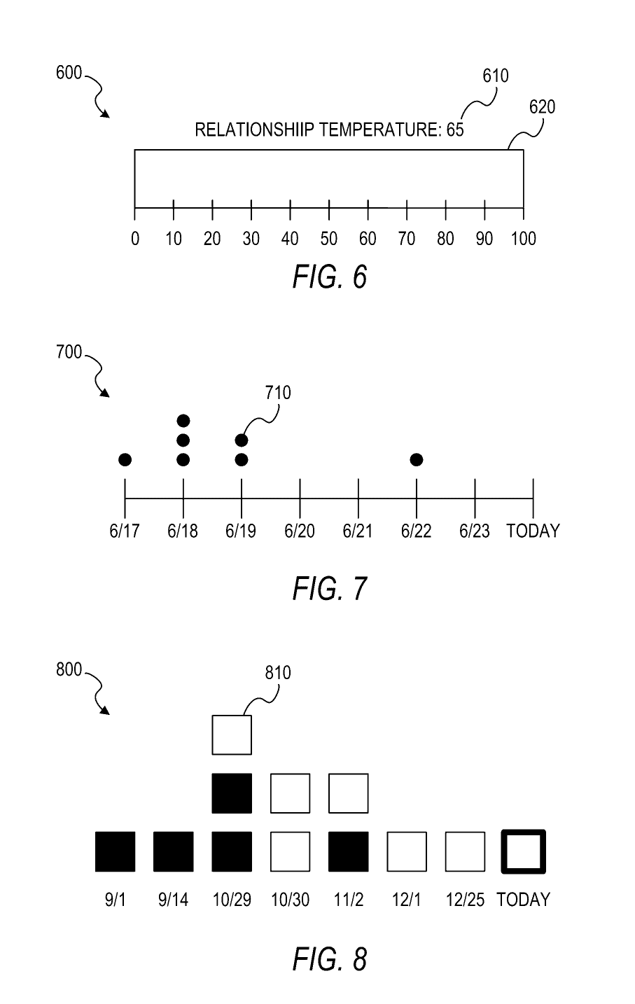

In some example embodiments, the content generated for display to the first user comprises an indication of the relationship temperature value. FIG. 6 illustrates a graphical representation 600 of a relationship temperature value, in accordance with an example embodiment. The graphical representation 600 comprises one indication 610 of a relationship temperature value in the form of text (e.g., “RELATIONSHIP TEMPERATURE: 65” in FIG. 6) and another indication 620 of the relationship temperature value in the form of a single-dimension metered bar graph or chart. Other forms of indications of the relationship temperature value are also within the scope of the present disclosure. As will be discussed in further detail below, the indication of the relationship temperature value can be displayed or otherwise presented to the user in a variety of contexts and environments.

In some example embodiments, the content generated for display to the user comprises a graphical representation of the user's actions with respect to one or more other users over a period of time. FIG. 7 illustrates a graphical representation 700 of recent touch points 710 of activity between users of a social networking service, in accordance with an example embodiment. Each touch point 710 corresponds to and represents an action that was performed by the user with respect to another user. The display of this content can be based on a determination that the relationship temperature value for the user with respect to the one or more other users is below a predetermined threshold. In this respect, the display of this content to the user can act as a notification to the user that his or her activity level with respect to the one or more other users is at a low level.

In some example embodiments, the content generated for display to the first user comprises a graphical representation of a plurality of opportunities for interaction by the first user with the one or more other users, the graphical representation indicating which of the plurality of opportunities have been acted upon by the first user and which of the plurality of opportunities have not been acted upon by the first user. FIG. 8 illustrates a graphical representation 800 of opportunities 810 for interaction, in accordance with an example embodiment. Each opportunity 810 is aligned with an indication of when the opportunity arose (e.g., the date). Each opportunity 810 corresponds to an opportunity that the user had, or has, to perform an action with respect to the one or more other users. The opportunities 810 can be displayed differently to indicate whether the opportunity was acted on or not acted on by the user. For example, in FIG. 8, opportunities 810 that were acted on by the user are displayed as black boxes, while opportunities 810 that were not acted on by the user are displayed as hollow (or white) boxes. Other configurations are within the scope of the present disclosure.

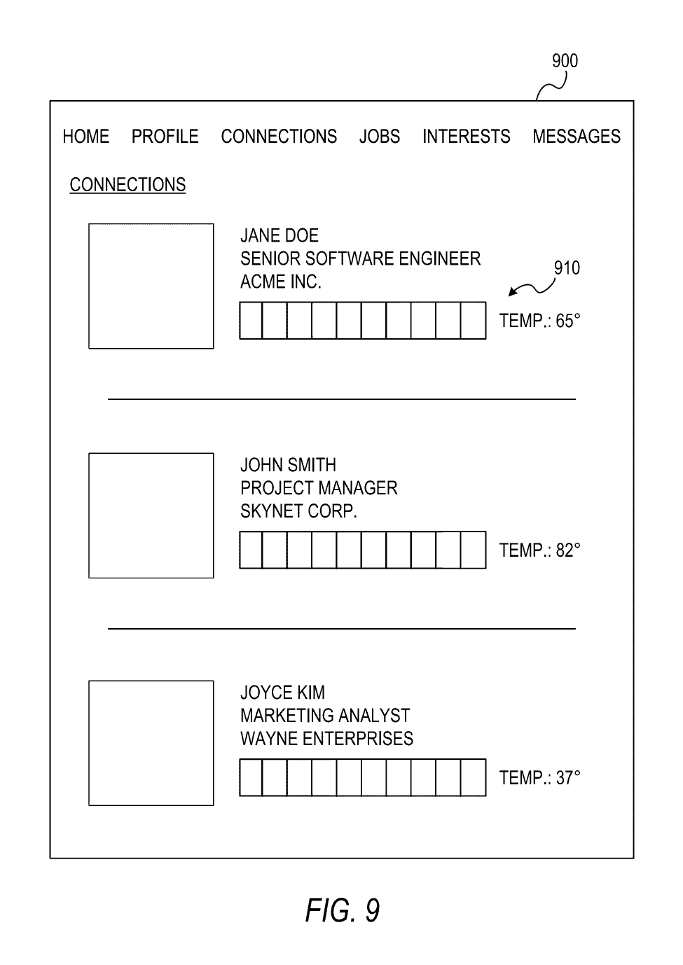

FIG. 9 illustrates a GUI 900 displaying corresponding indications 910 of relationship temperature values for connections of a user of a social networking service, in accordance with an example embodiment. In FIG. 9, the indications 910 comprise a textual representation of the relationship temperature value (e.g., “TEMP.: 65°” for Jane Doe in FIG. 9) and a single-dimension metered bar graph or chart. Other forms and configurations of the indications 910 are also within the scope of the present disclosure. In FIG. 9, the indications 910 are displayed on a page displaying the user's connections, with each indication 910 being displayed in a corresponding fashion with an identification of the connection (e.g., aligned vertically with the corresponding user to which the corresponding relationship temperature value relates). Other configurations are within the scope of the present disclosure.

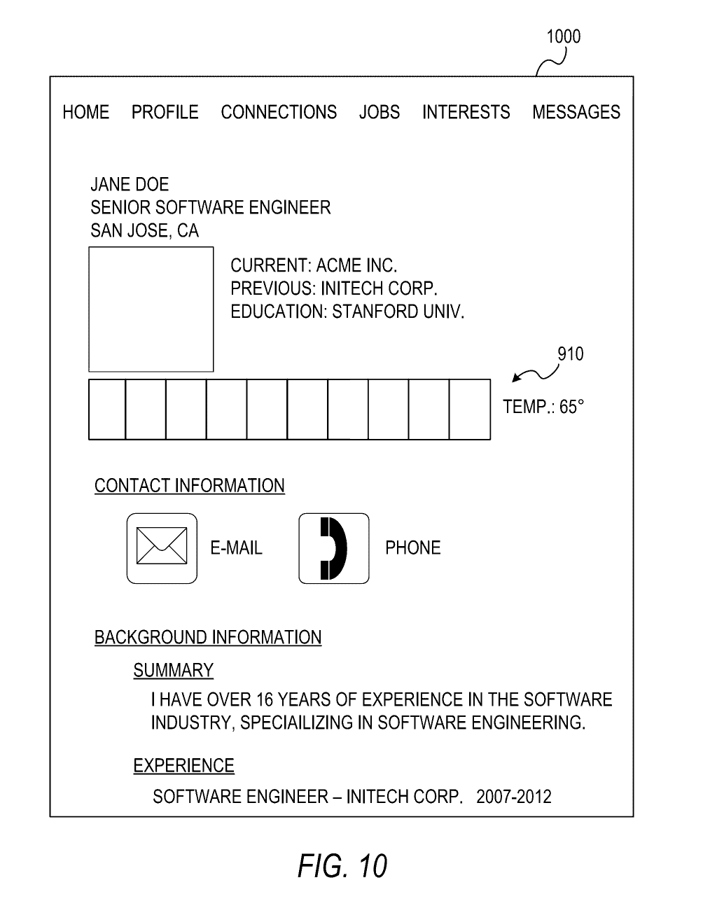

FIG. 10 illustrates GUI 1000 displaying an indication 910 of a relationship temperature value on a profile page of a user, in accordance with an example embodiment. For example, the user viewing the GUI 900 of FIG. 9 may have clicked on, or otherwise selected, one of the displayed connections (e.g., “Jane Doe”) and have been navigated to the profile page of that selected connection, where the indication 910 can again be displayed.

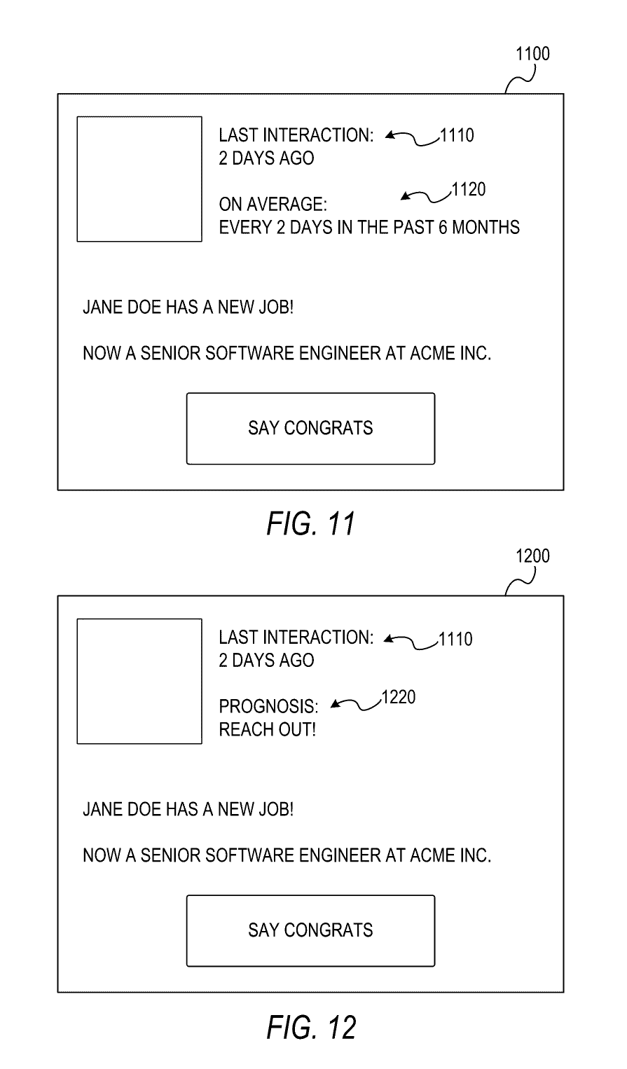

FIG. 11 illustrates GUI 1100 displaying indications 1110 and 1120 of social activity data, in accordance with an example embodiment. Indication 1110 indicates how long it has been since the user has interacted with a particular user. For example, in FIG. 11, the indication 1110 indicates that the user's last interaction with Jane Doe was 2 days ago. Indication 1120 indicates the frequency with which the user has been interacting with that particular user within a particular period of time. For example, in FIG. 11, the indication 1120 indicates that, on average, the user has been interacting with Jane Doe every 2 days in the past 6 months. These indications 1110 and 1120 can be displayed to the user based on an event associated with the target user occurring (e.g., Jane Doe having a new job). The timing of these indications being displayed to the user helps remind the user whether his or her relationship with the other user is becoming less active (e.g., cold).

In some example embodiments, the content generated for display to the first user comprises a prompting to perform an action with respect to the one or more other users. FIG. 12 illustrates GUI 1200 displaying indications 1110 and 1220 of social activity data, in accordance with an example embodiment. Indication 1110 in FIG. 12 is the same as in FIG. 11. However, indication 1220 comprises a prompting of the user to reach out (e.g., “Reach Out!”) to the other user. The content of this prompting can be determined based on the relationship temperature value between the two users. For example, a highly emphatic prompting (e.g., including a command with an exclamation mark) can be used based on a determination that the relationship temperature value is at a certain level (e.g., below a predetermined threshold) reflective of a cold relationship in terms of activity between the two users. Other types of promptings are also within the scope of the present disclosure.

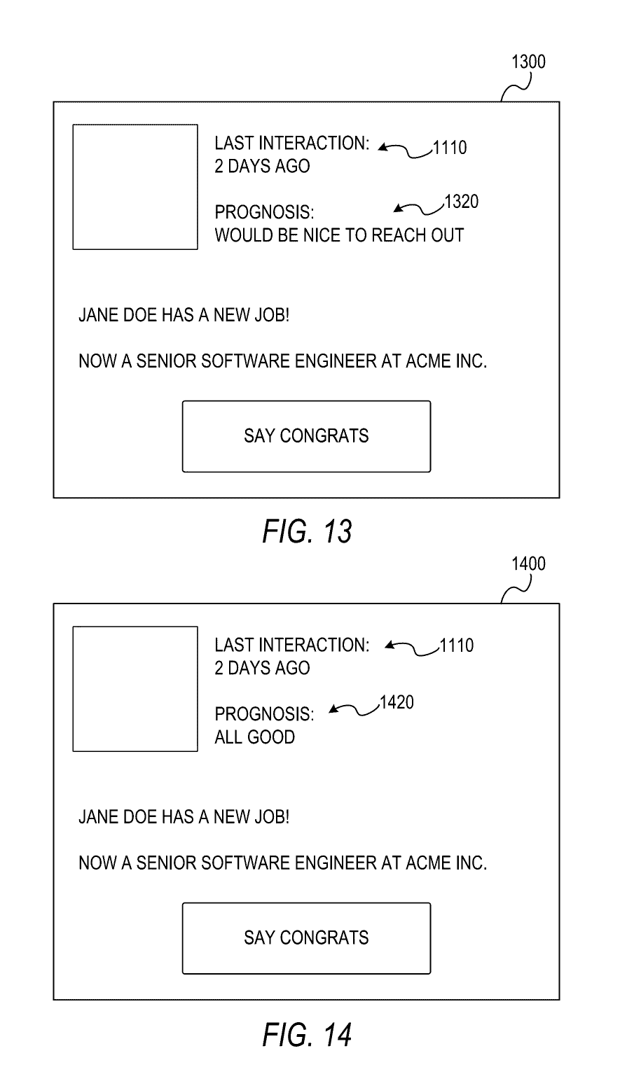

FIG. 13 illustrates GUI 1300 displaying indications 1110 and 1320 of social activity data, in accordance with an example embodiment. Indication 1110 in FIG. 13 is the same as in FIG. 11. However, indication 1320 comprises a suggestion to the user to reach out (e.g., “Would be nice to reach out”) to the other user. The content of this indication 1320 can be determined based on the relationship temperature value between the two users. For example, the suggestive tone, as opposed the emphatic command in FIG. 12, can be used based on a determination that the relationship temperature value is at a certain level (e.g., within a certain range) reflective of a medium relationship in terms of activity between the two users. Other types of indications are also within the scope of the present disclosure.

FIG. 14 illustrates GUI 1400 displaying indications 1110 and 1420 of social activity data, in accordance with an example embodiment. Indication 1110 in FIG. 14 is the same as in FIG. 11. However, indication 1420 comprises a notification that the user's relationship, in terms of interaction, is good (e.g., “All Good”). The content of this indication 1420 can be determined based on the relationship temperature value between the two users (e.g., the relationship temperature value being above a predetermined threshold) being reflective of a warm or hot relationship in terms of activity between the two users. Other types of indications are also within the scope of the present disclosure.

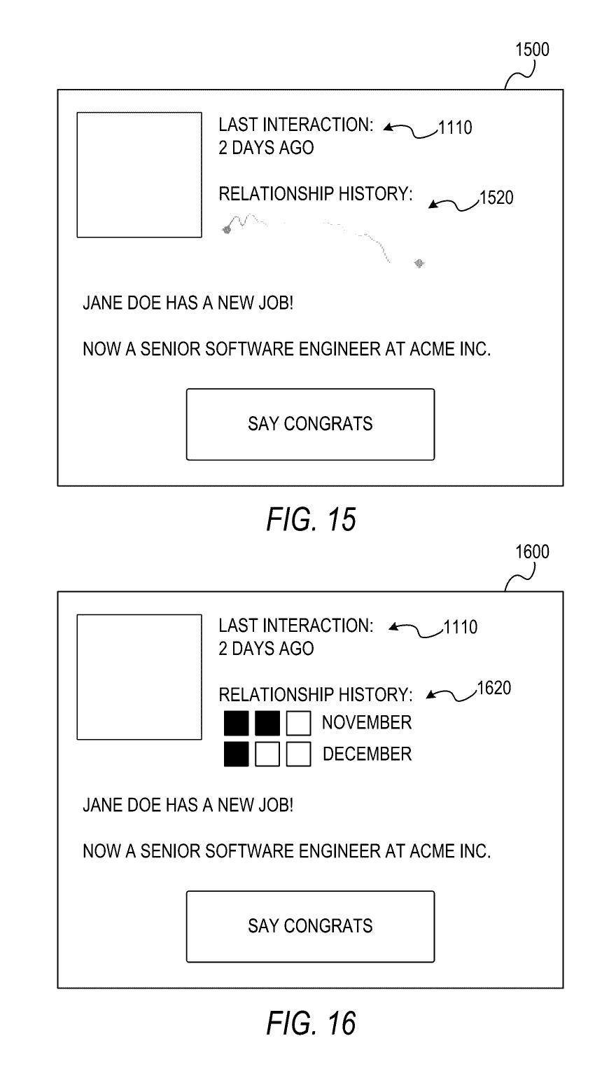

In some example embodiments, the content generated for display to the first user comprises a graphical representation of a relationship temperature value over a period of time. FIG. 15 illustrates GUI 1500 displaying indications 1110 and 1520 of social activity data, in accordance with an example embodiment. Indication 1110 in FIG. 15 is the same as in FIG. 11. However, indication 1520 comprises a graphical representation of a relationship temperature value over a period of time, with the indication 1520 in FIG. 15 indicating that the relationship temperature value has recently declined, as reflected by the gradual movement down of the line in the line graph when going left to right. Other configurations are also within the scope of the present disclosure.

FIG. 16 illustrates GUI 1600 displaying indications 1110 and 1620 of social activity data, in accordance with an example embodiment. Indication 1110 in FIG. 16 is the same as in FIG. 11. However, indication 1620 comprises a graphical representation of opportunities for interaction. Each opportunity corresponds to an opportunity that the user had, or has, to perform an action with respect to the other user. The opportunities are displayed differently to indicate whether the opportunity was acted on or not acted on by the user. For example, in FIG. 16, opportunities that were acted on by the user are displayed as black boxes, while opportunities that were not acted on by the user are displayed as hollow (or white) boxes. Other configurations are within the scope of the present disclosure.

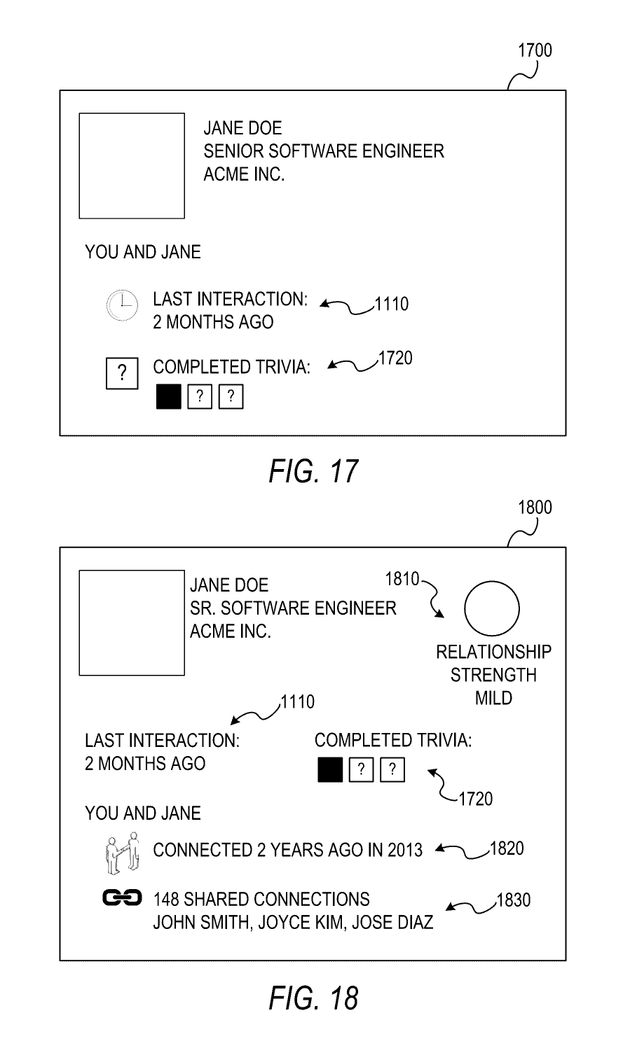

FIG. 17 illustrates GUI 1700 displaying indications 1110 and 1720 of social activity data, in accordance with an example embodiment. Indication 1110 in FIG. 17 is the same as in FIG. 11. However, indication 1720 comprises a graphical representation of opportunities for interaction. In this example, the opportunities comprise opportunities for the user to answer questions about the other user in order to reflect how much the user in engaged with and interacting with the other user, and thereby increase the corresponding relationship temperature value, as previously discussed. The opportunities are displayed differently to indicate whether the opportunity was acted on or not acted on by the user. For example, in FIG. 17, opportunities that were acted on by the user are displayed as black boxes, white opportunities that were not acted on by the user are displayed as hollow (or white) boxes. In some example embodiments, each graphical representation of an opportunity to answer a question is configured to be selected by the user, and thereby trigger the display of the corresponding questions and selectable answer options for the question to the user, which can then be used as social activity data, as previously discussed. Other configurations are within the scope of the present disclosure.

FIG. 18 illustrates GUI 1800 displaying an indication 1810 of a relationship temperature value and indications 1110, 1720, 1820, and 1830 of social activity data, in accordance with an example embodiment. Indications 1110 and 1720 are configured as previously discussed. Indication 1810 is configured to indicate the relationship temperature value of the user with respect to the other user. This indication 1810 can comprise a textual indication (e.g., “MILD”), as well as an indication based on color or shading. For example, the higher the relationship temperature value, the darker the shading of the circle in FIG. 18. Light shading is used in FIG. 18 to represent a mild relationship temperature value. Indication 1820 indicates the last time the user connected with the other user, and indication 1830 indicates the number of common connections (e.g., connection strength) between the user and the other user. Other configurations are within the scope of the present disclosure.

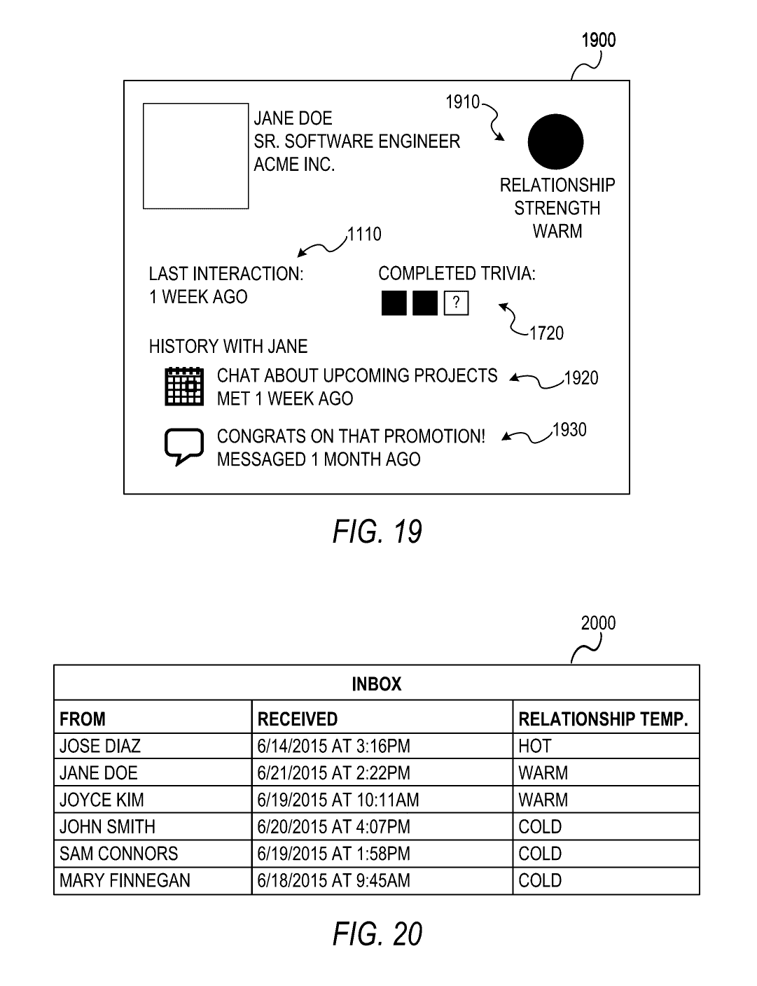

FIG. 19 illustrates GUI 1900 displaying an indication 1910 of a relationship temperature value and indications 1110, 1720, 1920, and 1930 of social activity data, in accordance with an example embodiment. Indications 1110 and 1720 are configured as previously discussed. Indication 1910 is configured to indicate the relationship temperature value of the user with respect to the other user. This indication 1910 can comprise a textual indication (e.g., “WARM”), as well as an indication based on color or shading. For example, the higher the relationship temperature value, the darker the shading of the circle in FIG. 19. Dark shading is used in FIG. 19 to represent a warm relationship temperature value. Indications 1920 and 1930 indicate the two most recent times the user has interacted with the other user. Other configurations are within the scope of the present disclosure.

In some example embodiments, the content generated for display to the first user comprises an inbox of messages of the first user, and the generating of the content comprises determining an order of messages in the inbox based on the relationship temperature values corresponding to the recipient of the message (e.g., the previously-discussed acting user) and the sender of the message (e.g., the previously-discussed target user). FIG. 20 illustrates an inbox 2000 of a user having messages ordered from top to bottom based on corresponding relationship temperature values of the user with respect to the senders of the messages, in accordance with an example embodiment. In the example embodiment of FIG. 20, the messages are ordered from top to bottom in descending order of corresponding relationship temperature values. Accordingly, the message from Jose Diaz is displayed at the top of the inbox 2000 based on the corresponding relationship temperature between the user and Jose Diaz being the highest. In this example, the relationship temperature values are provided as three different levels: HOT, WARM, and COLD. The different levels can correspond to different ranges the previously discussed numerical scores. However, it is contemplated that other configurations are also within the scope of the present disclosure.

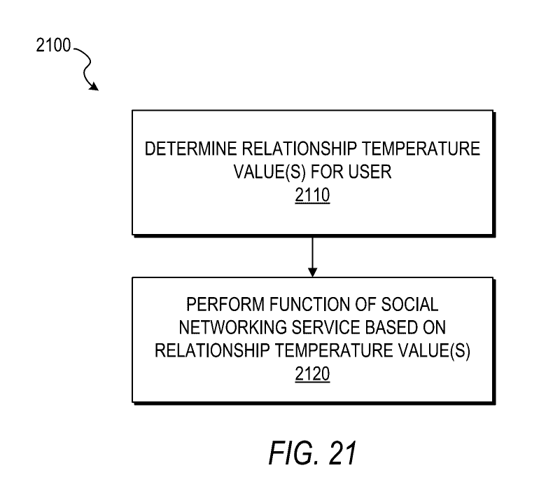

FIG. 21 is a flowchart illustrating a method 2100 of performing functions of a social networking service using relationship temperature values, in accordance with an example embodiment. Method 2100 can be performed by processing logic that can comprise hardware (e.g., circuitry, dedicated logic, programmable logic, microcode, etc.), software (e.g., instructions run on a processing device), or a combination thereof. In one implementation, the method 2100 is performed by the relationship temperature system 216 of FIGS. 2-3, or any combination of one or more of its modules, as described above.

At operation 2110, the temperature determination module 310 determines one or more relationship temperature values for a user, in accordance any combination of features discussed with respect to FIGS. 3-20. At operation 2120, the content generation module 320 performs a function of an online social networking service based on the relationship temperature value(s), in accordance with any combination of features discussed with respect to FIGS. 3-20. It is contemplated that any of the other features described within the present disclosure can be incorporated into method 2100.

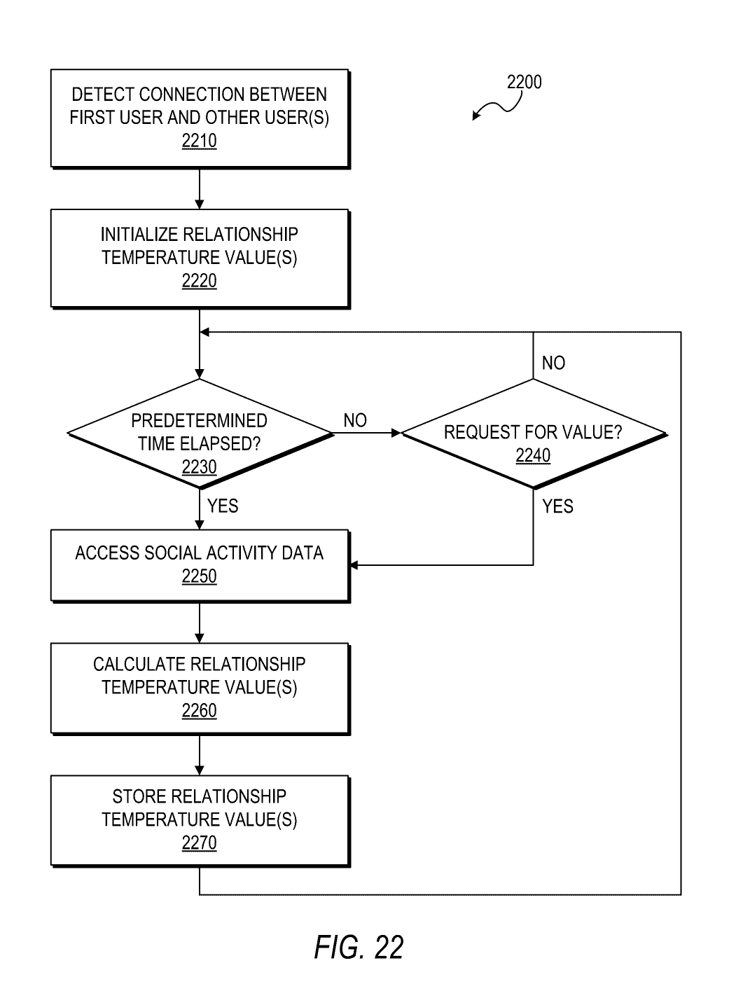

FIG. 22 is a flowchart illustrating a method 2200 of determining one or more relationship temperature values, in accordance with an example embodiment. Method 2200 can be performed by processing logic that can comprise hardware (e.g., circuitry, dedicated logic, programmable logic, microcode, etc.), software (e.g., instructions run on a processing device), or a combination thereof. In one implementation, the method 2200 is performed by the relationship temperature system 216 of FIGS. 2-3, or any combination of one or more of its modules (e.g., temperature determination module 310), as described above.

At operation 2210, an establishment of a connection between a first user and one or more other users is detected, as previously discussed. At operation 2220, in response to the detection of the establishment of the connection, the relationship temperature value is initialized based on a common number of connections shared by the first user and the other user(s), as previously discussed.

At operation 2230, it is determined whether or not a time requirement for a scheduled update of the relationship temperature value has been satisfied (e.g., has a predetermined amount of time elapsed), as previously discussed. If the time requirement has not been satisfied, then, at operation 2240, it is determined whether or not a request to perform an update of the relationship temperature value has been received (e.g., has the content generation module 320 requested an updated relationship temperature value), as previously discussed. If it is determined that such a request has not been received, then the method 2200 returns to operation 2230.

If either it has been determined, at step 2230, that the time requirement has been satisfied or it has been determined, at step 2240, that a request for an updated relationship temperature value has been received, then the method 2200 proceeds to operation 2250, where social activity data is accessed or received, as previously discussed. At operation 2260, one or more relationship temperature values are calculated, or otherwise determined, as previously discussed. At operation 2270, the one or more relationship temperature values are stored in a database, as previously discussed. The stored values can be later accessed and retrieved for use by one or more functions of the social networking service, as previously discussed. In some example, embodiments, a relationship temperature value can be calculated in real-time based on a request by a function of the social networking service and immediately used by the function without the calculated value having to be stored for later access and retrieval.

It is contemplated that any of the other features described within the present disclosure can be incorporated into method 2200.

In some example embodiments, the relationship temperature system 216 comprises an offline component and an online component, with which the relationship temperature system 216 can bootstrap the temperature value calculations, support real-time changes of the temperature values when users interact with each other, and aggregate the real-time changes throughout the day into history data.

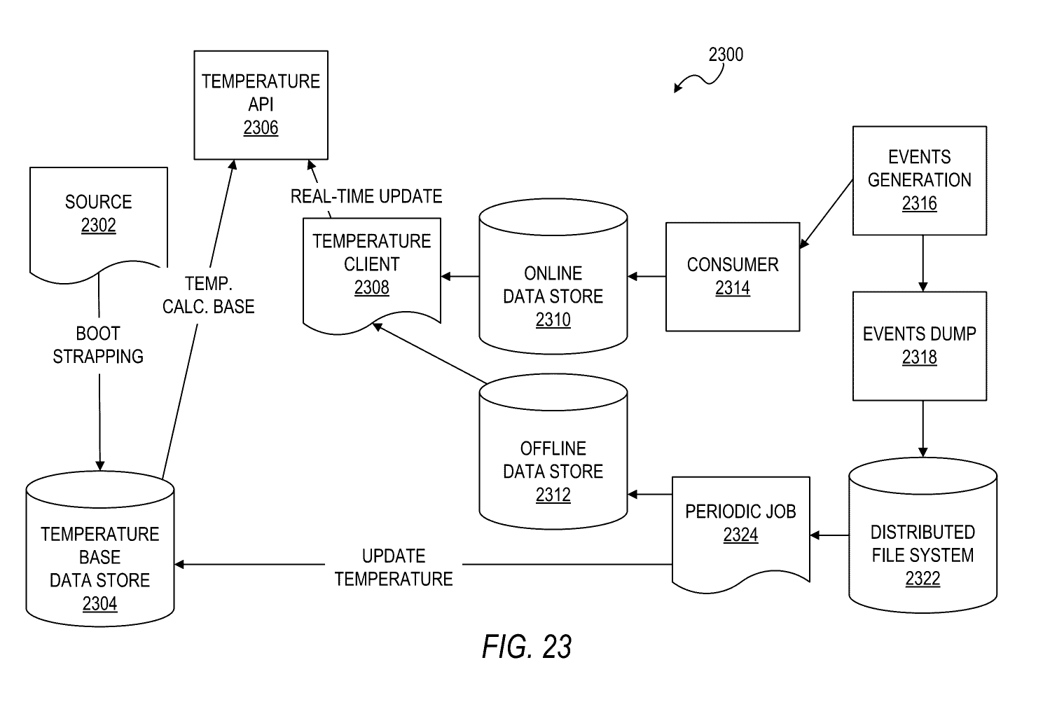

FIG. 23 is a block diagram illustrating a system architecture 2300, in accordance with an example embodiment. In some example embodiments, the system architecture 2300 is implemented within the relationship temperature system 216. The relationship temperature system 216 can be configured to perform real-time analytics on large volume of structured data, namely various tracking events emitted from a connected application (e.g., a social networking service application). An online data analytics platform, comprising a temperature client 2308, an online data store 2310, and an offline data store 2312 can be used as a building block for the system architecture 2300. This online data analytics platform can provide optimized query access to both online e.g., today) and offline (e.g., x days old) data, and can support a rich set of query such as sum, average, count, top k and faceted search over a specific time range. This online data analytics platform can also be horizontally scalable and support a customizable sharding strategy. The online data analytics platform allows efficient slicing and dicing on data injected into the online and offline data stores 2310 and 2312, without requiring huge developmental and operational cost. In some example embodiments, the system architecture 2300 also comprises a temperature base data store 2304 (e.g., a distributed key-value storage system) configured to persist daily (or other periodic) temperature values for pairs of users or members.

A stream processing job can observe user activity or action events and generate a corresponding relationship temperature change event accordingly. The online data store 2310 can then consume the relationship temperature change event and populate real-time information on how the relationship temperature between a member pair has changed (e.g., increased) throughout the day (or over some other period).

One or more sources 2302 (e.g., a data platform service API) can be employed to bootstrap the temperature base data store 2304 for the calculation of a base value for the relationship temperature value. In some example embodiments, the relationship temperature value is based on a connection strength between a member pair. During the course of the day (or over some other period), upon receiving client requests, a temperature API 2306 of the system architecture 2300 can calculate a current temperature by querying the temperature base data store 2304 to get the temperature (calculated the day before) at the beginning of the day (or using some other period-based configuration), querying the online and offline data stores 2310 and 2312 to obtain real-time temperature changes due to user interactions (e.g., number of likes, comments, messages, meetings, etc.), and generating the temperature value by adding the temperature at the beginning of the day and the real-time changes multiplied by a co-efficient (or using some other form of weighting).

In some example embodiments, at the end of day (pr at the end of some other period), a periodic job is performed to update the daily temperature value for a member pair by retrieving all relationship temperature change events, such as via an events generation 2316, events dump 2318 and consumer 2314 of a distributed publish-subscribe messaging system (e.g., Apache Kafka), and adding all of the changes throughout the day (or some other period) to the old daily temperature value, thereby deriving the new daily temperature that can be used as base for the next day's calculation. If no such relationship temperature change events can be found due to no interactions between the member pair, then the old daily temperature value can be decreased, which becomes the new daily temperature that can be used as base for the next day's calculation. Records of the relationship temperature change events can be stored in a distributed file system 2322 (e.g., Apache Hadoop).

In some example embodiments, the relationship temperature increases over the course of a day (or some other period) when a user takes action, but only decreases at the end of the day (Or some other period) if the user does not take any action during that day (or other period). The temperature does not decrease hourly simply because a pair of users did not interact with each other during that hour. Different periods on which to base the calculations and changes in temperature can be employed.

In some example embodiments, the temperature API 2306 supports the query of temperature for a member on each connection pair, on each connection grouping, and/or on a user's whole network, given a specified time range. Here are sample queries:
1) // Get the current pair temperature between a member and his connection “urn:li:member:9”
   GET /PairTemperature?target=urn:li:member:9
2) // Get the current pair temperature between a member and his connections “urn:li:member:9, urn:li:member:10, urn:li:member:11”
   (BATCH) GET
   /PairTemperature?targets=urn:li:member:9&targets=urn:li:member:10&targets=urn:li:member:11
3) // Get the current overall network temperature for a given member “urn:li:member:9”
   GET /NetworkTemperature?member=urn:li:member:9

In addition to the network temperature, the temperature API 2306 can also support slicing and dicing on a user's temperature over a given period of time:
1) // For a given member urn:li:member:9's connection who work at a particular company (e.g., “Company”), get the current average network temperature
   GET/TemperatureAggregate?member=urn:li:member:9&q=average&filterFacet=currentCompany&FacetValue=Compamy
2) // For a given member urn:li:member:9's connection, get the top 5 cluster group by current company and rank by average network temperature
   GET/TemperatureAggregate?metnber=urn:li:member:9&q=rank&groupBy=currentCompany&sortBy=NetworkTemperature

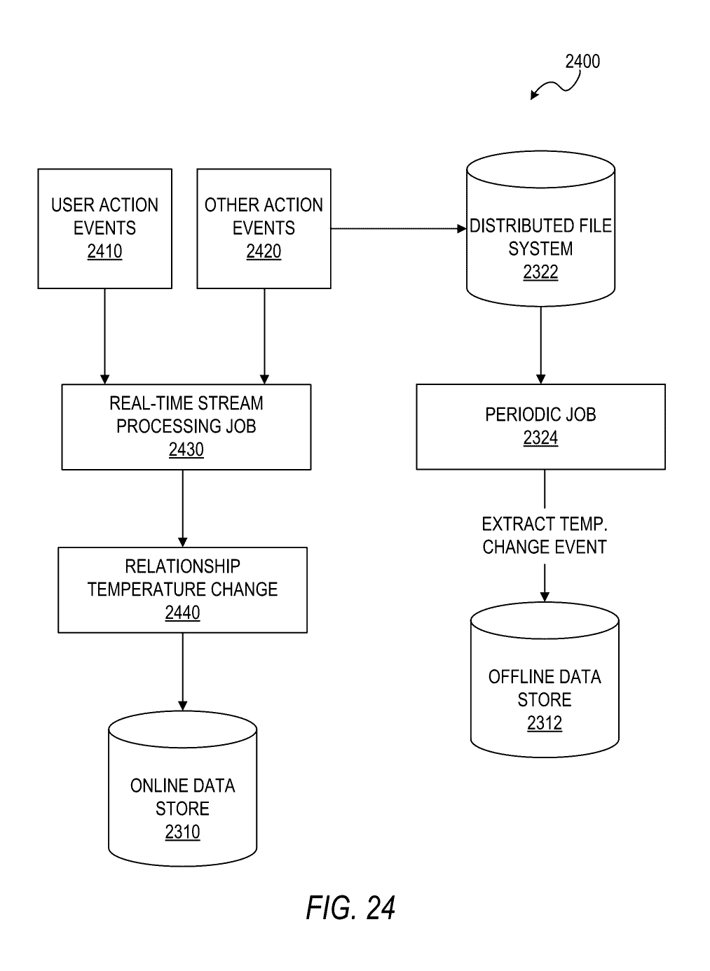

FIG. 24 is a flow diagram 2400 illustrating maintenance of online and offline data stores 2310 and 2312, in accordance with an example embodiment. In some example embodiments, the cluster of online and offline data stores 2310 and 2312 are bootstrapped, with data corresponding to user and other action or events 2410 and 2420 being transmitted to both the online and offline data stores 2310 and 2312. In some example embodiments, a data serialization (e.g., Apache Avro) schema is defined to represent temperature change upon user action. This schema can be used by both offline jobs and online jobs. An online real-time stream processing job 2430 is performed to inject real-time action information to a handler of the online data store 2310. The job 2430 can observe events among a member pair (e.g., user A liked user B's update, user A messaged user B, user A invited user B), and then generate a relationship temperature change event 2440, which can be stored in the online data store 2310. Periodic jobs 2324 are performed to load offline action information from the distributed file system 2322 to a data handler of the offline data store 2312.

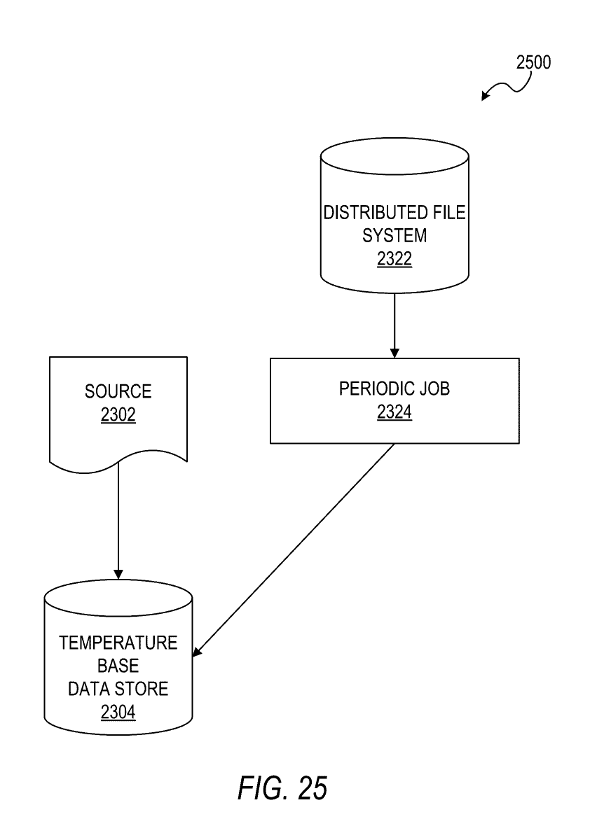

FIG. 25 is a flow diagram 2500 illustrating maintenance of the temperature base data store 2304 for persisting periodic temperature values, in accordance with an example embodiment. In some example embodiments, the source 2302 bootstraps the temperature base data store 2304, and the temperature base data store 2304 is updated periodically (e.g., daily) with information from the distributed file system 2322 via the periodic job 2324.

As previously discussed, in some example embodiments, the default relationship temperature value is derived from a member (or user) pair's connection strength, and is overlaid with other information such as number of interactions within a specified period (e.g., within the last 90 days). Throughout the day, whenever two members interact with each other via a connected application (e.g., an application of a social networking service), unified action events are fired, which will be consumed by the real-time stream processing job 2430. This real-time stream processing job 2430 emits a relationship temperature change event 2440 to capture the change. At the end of day, a periodic job 2324 is performed to extract all relationship temperature change events and apply the delta on all related member pair's temperature value in the temperature base store 2304. If there is no interaction between a member pair on that day, then the temperature value in the temperature base store 2304 is decreased accordingly due to the lack of activity.

### Example Mobile Device

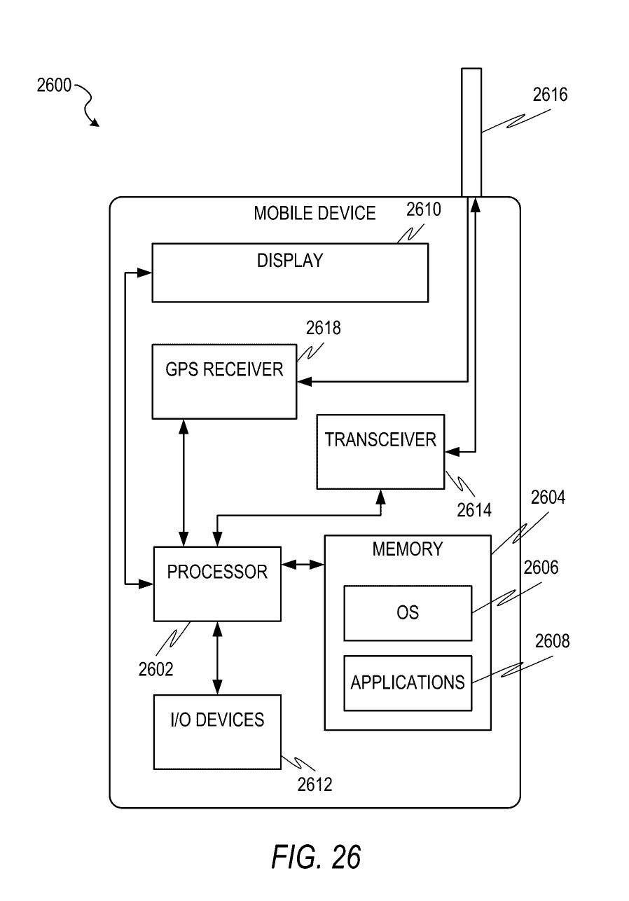

FIG. 26 is a block diagram illustrating a mobile device 2600, according to an example embodiment. The mobile device 2600 can include a processor 2602. The processor 2602 can be any of a variety of different types of commercially available processors suitable for mobile devices 2600 (for example, an XScale architecture microprocessor, a Microprocessor without Interlocked Pipeline Stages (MIPS) architecture processor, or another type of processor). A memory 2604, such as a random access memory (RAM), a Flash memory, or other type of memory, is typically accessible to the processor 2602. The memory 2604 can be adapted to store an operating system (OS) 2606, as well as application programs 2608, such as a mobile location enabled application that can provide location-based services (LBSs) to a user. The processor 2602 can be coupled, either directly or via appropriate intermediary hardware, to a display 2610 and to one or more input/output (I/O) devices 2612, such as a keypad, a touch panel sensor, a microphone, and the like. Similarly, in some embodiments, the processor 2602 can be coupled to a transceiver 2614 that interfaces with an antenna 2616. The transceiver 2614 can be configured to both transmit and receive cellular network signals, wireless data signals, or other types of signals via the antenna 2616, depending on the nature of the mobile device 2600. Further, in some configurations, a GPS receiver 2618 can also make use of the antenna 2616 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

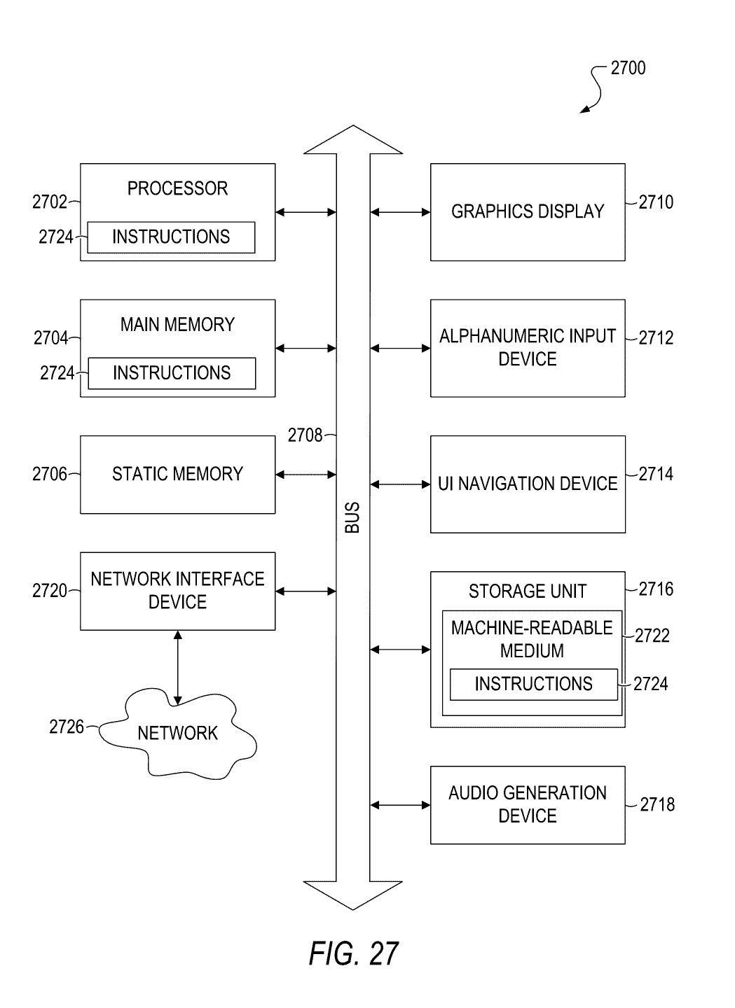

FIG. 27 is a block diagram of an example computer system 2700 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2700 includes a processor 2702 (e.g., a central processing unit (CPU), a graphics processing unit (GPU) or both), a main memory 2704 and a static memory 2706, which communicate with each other via a bus 2708. The computer system 2700 may further include a video display unit 2710 (e.g., a liquid crystal display (LCD) or a cathode ray tube (CRT)). The computer system 2700 also includes an alphanumeric input device 2712 (e.g., a keyboard or a touch-sensitive display screen), a user interface (IA) navigation device 2714 (e.g., a mouse), a disk drive unit 2716, a signal generation device 2718 (e.g., a speaker) and a network interface device 2720.

### Machine-Readable Medium

The disk drive unit 2716 includes a machine-readable medium 2722 on which is stored one or more sets of instructions and data structures (e.g., software) 2724 embodying or utilized by any one or more of the methodologies or functions described herein. The instructions 2724 may also reside, completely or at least partially, within the main memory 2704 and/or within the processor 2702 during execution thereof by the computer system 2700, the main memory 2704 and the processor 2702 also constituting machine-readable media.

While the machine-readable medium 2722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure; or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 2724 may further be transmitted or received over a communications network 2726 using a transmission medium. The instructions 2724 may be transmitted using the network interface device 2720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
accessing a relationship temperature value for a first user of an online social networking service, the relationship temperature value indicating a measurement of activity of the first user with respect to one or more other users of the online social networking service; and
performing, by a machine having a memory and at least one processor, a function of the online social networking service based on the relationship temperature value, the function comprising generating content for display to the first user.

2. The method of claim 1, wherein the content generated for display to the first user comprises an indication of the relationship temperature value.

3. The method of claim 1, wherein the content generated for display to the first user comprises a prompting to perform an action with respect to the one or more other users.

4. The method of claim 1, wherein the content generated for display to the first user comprises a graphical representation of a plurality of opportunities for interaction by the first user with the one or more other users, the graphical representation indicating which of the plurality of opportunities have been acted upon by the first user and which of the plurality of opportunities have not been acted upon by the first user.

5. The method of claim 1, wherein the content generated for display to the first user comprises a graphical representation of the relationship temperature value over a period of time, the graphical representation comprising different values of the relationship temperature value at different points during the period of time.

6. The method of claim 1, wherein the content generated for display to the first user comprises an inbox of messages of the first user, the generating of the content comprising determining an order of messages in the inbox based on the relationship temperature value.

7. The method of claim 1, wherein the relationship temperature value is based on one or more signals, the one or more signals comprising at least one of the first user establishing a connection with one of the one or more other users, the first user commenting on an event associated with the one of the one or more other users, the first user sending a message to the one of the one or more other users, the first user calling the one of the one or more other users, the first user having a meeting with the one of the one or more other users, the first user inviting the one of the one or more other users to use an online service, the first user being within a predetermined proximity of the one of the one or more other users, the first user following the one of the one or more other users, the first user liking an event associated with the one of the one or more other users, and the first user answering a question about the one of the one or more other users.

8. The method of claim 1, wherein the relationship temperature value comprises a numerical score.

9. The method of claim 1, wherein the one or more other users consists of a second user, and the relationship temperature value represents a measurement of activity by the first user with respect to the second user.

10. The method of claim 1, wherein the one or more other users comprises a plurality of other users, and the relationship temperature value represents a measurement of activity by the first user with respect to the plurality of other users.

11. The method of claim 7, wherein the one or more other users consists only of the plurality of other users, the plurality of other users consists only of all of the users identified as connections of the first user in the online social networking service, and the relationship temperature value represents a measurement of activity by the first user with respect to all of the users identified as connections of the first user in the online social networking service.

12. The method of claim 1, further comprising:
storing the relationship temperature value as a base value in a data store, the base value corresponding to the end of a first period;
aggregating social activity data corresponding to the first user and the one or more other users during a second period subsequent to the first period, the social activity data comprising one or more signals, each of the one or more signals indicating a corresponding activity of the first user with respect to one of the one or more other users;
calculating an updated relationship temperature value using the base value in the data store and social activity data; and
storing the updated relationship temperature value as the base value in the data store in response to a determination that the second period has ended.

13. A system comprising:
at least one processor; and
a non-transitory machine-readable medium embodying a set of instructions that, when executed by the at least one processor, cause the at least one processor to perform operations, the operations comprising:
accessing a relationship temperature value for a first user of an online social networking service, the relationship temperature value indicating a measurement of activity of the first user with respect to one or more other users of the online social networking service; and
performing a function of the online social networking service based on the relationship temperature value, the function comprising generating content for display to the first user.

14. The system of claim 13, wherein the content generated for display to the first user comprises an indication of the relationship temperature value.

15. The system of claim 13, wherein the content generated for display to the first user comprises a prompting to perform an action with respect to the one or more other users.

16. The system of claim 13, wherein the content generated for display to the first user comprises a graphical representation of a plurality of opportunities for interaction by the first user with the one or more other users, the graphical representation indicating which of the plurality of opportunities have been acted upon by the first user and which of the plurality of opportunities have not been acted upon by the first user.

17. The system of claim 13, wherein the content generated for display to the first user comprises a graphical representation of the relationship temperature value over a period of time, the graphical representation comprising different values of the relationship temperature value at different points during the period of time.

18. The system of claim 13, wherein the content generated for display to the first user comprises an inbox of messages of the first user, the generating of the content comprising determining an order of messages in the inbox based on the relationship temperature value.

19. The system of claim 13, wherein the relationship temperature value is based on one or more signals, the one or more signals comprising at least one of the first user establishing a connection with the one of the one or more other users, the first user commenting on an event associated with the one of the one or more other users, the first user sending a message to the one of the one or more other users, the first user calling the one of the one or more other users, the first user having a meeting with the one of the one or more other users, the first user inviting the one of the one or more other users to use an online service, the first user being within a predetermined proximity of the one of the one or more other users, the first user following the one of the one or more other users, the first user liking an event associated with the one of the one or more other users, and the first user answering a question about the one of the one or more other users.

20. A non-transitory machine-readable medium embodying a set of instructions that, when executed by a processor, cause the processor to perform operations, the operations comprising:
receiving a relationship temperature value for a first user of an online social networking service, the relationship temperature value indicating a measurement of activity of the first user with respect to one or more other users of the online social networking service; and
performing a function of the online social networking service based on the relationship temperature value, the function comprising generating content for display to the first user.
